(19) United States
(12) Patent Application Publication
(10) Pub. No.: US 2014/0328092 A1
(43) Pub. Date: Nov. 6, 2014

(54) INVERTER DEVICE AND INVERTER GENERATOR

(71) Applicant: Toshiba Kikai Kabushiki Kaisha, Tokyo (JP)

(72) Inventors: Narutoshi YOKOKAWA, Mishima-shi (JP); Tomoyuki HOSHIKAWA, Numazu-shi (JP); Kazumi MURATA, Numazu-shi (JP); Masayuki WATANABE, Izu-shi (JP); Junichi KANAI, Niigata-shi (JP); Naoyuki MASHIMA, Tsubame-shi (JP)

(73) Assignee: Toshiba Kikai Kabushiki Kaisha, Tokyo (JP)

(21) Appl. No.: 14/263,745

(22) Filed: Apr. 28, 2014

(30) Foreign Application Priority Data
May 1, 2013 (JP) 2013-096231

(51) Int. Cl. H02M 1/12

(52) U.S. Cl. CPC H02M 1/12
USPC 363/41

(57) ABSTRACT

An inverter device includes a voltage command value output unit that outputs a voltage command value, voltage sensors that detect output voltage from a switching circuit, a Fourier transform unit that performs frequency analysis on the output voltage detected by the respective voltage sensors, and a voltage correction value calculation unit that obtains harmonics with respect to a drive frequency of the switching circuit subjected to the frequency analysis by the Fourier transform unit and obtains a voltage correction coefficients for correcting the voltage command value so as to cancel the harmonics. The voltage correction value calculation unit calculates coefficients each for each degree of the harmonics and determines whether the coefficients converges when calculating the coefficients so as to obtain the voltage correction coefficients based on the coefficients which are determined to converge.

### BACKGROUND OF THE INVENTION

1. Field of the Invention

The present invention relates to an inverter device and an inverter generator. More particularly, the present invention relates to a technology of removing harmonics containing in electric power output from an inverter.

2. Description of the Related Art

An inverter device used in an inverter generator turn on/off DC power output from a converter by use of electric switches such as semiconductor switches so as to generate AC power of a sine wave with a desired frequency.

However, harmonics of the desired frequency are generated and superposed on the sine wave so that distortion is caused on the sine wave. In such a case, the sine wave with high accuracy cannot be ensured, loads (such as a motor, an electric light, and a personal computer) connected to an inverter device cannot be operated stably, and problems of noise, oscillation, and heat generation are caused accordingly. In view of this, the generation of harmonics is required to be prevented. There is known a method for preventing generation of harmonics as disclosed in JP H10-145972 A (Patent Literature 1).

Patent Literature 1 discloses that load current flowing in a load connected to an inverter device is subjected to Fourier analysis, and degrees of harmonics are obtained so as to cancel respective degree harmonics. However, according to the disclosure of Patent Literature 1, a phase change of AC voltage derived from impedance characteristics of the load is not taken into consideration. That is, a voltage phase may change because of the load connected to the inverter device, and the voltage phase may greatly lag behind a current phase because of a capacitor and the like installed in a power supply circuit if a large number of computers are connected to the inverter device under recent circumstances. Such a large change in phase causes the problem that the harmonics cannot be prevented.

### SUMMARY OF THE INVENTION

The conventional example disclosed in Patent Literature 1 has a fault that cancelling of the harmonics is not controlled properly when the difference in phases between the current and the voltage increases since change of the voltage phase is not taken into consideration.

The present invention has been made in order to solve the conventional problem. It is an object of the present invention to provide an inverter device and an inverter generator capable of cancelling harmonics with high accuracy even if a phase difference is caused.

An inverter device according to a first aspect of the present invention includes:

a switching circuit that converts DC power into AC power based on a voltage command value; and a controller that controls operation of the switching circuit. The controller includes: a voltage command value output unit that outputs the voltage command value; a voltage sensor that detects an output voltage from the switching circuit; a frequency analysis unit that performs frequency analysis on the output voltage detected by the voltage sensor; and a correction signal generation unit that obtains harmonics with respect to a drive frequency of the switching circuit subjected to the frequency analysis by the frequency analysis unit and obtains voltage correction coefficients for correcting the voltage command value so as to cancel the harmonics. The correction signal generation unit calculates coefficients each for each degree of the harmonics and determines whether each of the coefficients converges when calculating the coefficients so as to obtain the voltage correction coefficients based on the coefficients which are determined to converge.

The correction signal generation unit preferably determines that the coefficient converges when each of the calculated coefficients for each degree of the harmonics is within a predetermined threshold value.

The correction signal generation unit preferably determines that each of the coefficients converges when a measurement time for each of the coefficients is shorter than a predetermined period of time even when each of the coefficients for each degree of the harmonics is not within the predetermined threshold value.

An inverter generator according to a second aspect of the present invention includes: a prime mover; a synchronous motor connected to the prime mover; a converter connected to the synchronous motor; an inverter device connected to the converter; and a capacitor installed between the converter and the inverter device, wherein the prime mover rotates the synchronous motor, electric power generated by the synchronous motor is changed into DC power, the DC power is converted into AC power having a desired frequency by the inverter device. The inverter device includes: a switching circuit that converts the DC power into the AC power based on a voltage command value; and a controller that controls operation of the switching circuit. The controller includes: a voltage command value output unit that outputs the voltage command value; a voltage sensor that detects an output voltage from the switching circuit; a frequency analysis unit that performs frequency analysis on the output voltage detected by the voltage sensor; and a correction signal generation unit that obtains harmonics with respect to a drive frequency of the switching circuit subjected to the frequency analysis by the frequency analysis unit and obtains voltage correction coefficients for correcting the voltage command value so as to cancel the harmonics. The correction signal generation unit calculates coefficients for each degree of the harmonics and determines whether each the coefficients converges when calculating each of the coefficients so as to obtain the voltage correction coefficients based on the coefficients which are determined to converge.

The correction signal generation unit preferably determines that each of the coefficients converges when the calculated coefficient for each degree of the harmonics is within a predetermined threshold value.

The correction signal generation unit preferably determines that each of the coefficients converges when a measurement time for each of the coefficients is shorter than a predetermined period of time even when the coefficient for each degree of the harmonics is not within the predetermined threshold value.

In the inverter device according to the first aspect of the present invention and the inverter generator according to the second aspect of the present invention, the output voltage of the inverter device is detected and subjected to the frequency analysis so as to calculate the coefficients of the harmonics for each degree of the output voltage frequency. When one of the coefficients is conceived to converge in a particular value, the voltage correction coefficient with respect to this coefficient is obtained. The voltage correction coefficient obtained for each degree is added so as to correct the voltage command value. Since only the coefficients of the degrees which converges are used to obtain the correction coefficients, the voltage control with a high speed response and high stability can be ensured even when there is a large difference in phase between voltage and current supplied to the load and even when a feedback control of the voltage command value is not stable.

### BRIEF DESCRIPTION OF THE DRAWINGS

FIG. 1 is a block diagram illustrating a constitution of an inverter generator equipped with an inverter device according to an embodiment and a load connected thereto.

FIG. 2 is a block diagram illustrating a specific constitution of a controller installed in the inverter device according to the embodiment.

FIG. 3 is a block diagram illustrating a specific constitution of a compensation circuit installed in the controller in the inverter device according to the embodiment.

FIG. 4 is a block diagram illustrating a specific constitution of an electric angle generation unit installed in the controller in the inverter device according to the embodiment.

FIG. 5 is a block diagram illustrating a specific constitution of a Fourier transform unit installed in the controller in the inverter device according to the embodiment.

FIG. 6 is a block diagram illustrating a specific constitution of a calculator for calculating each correction coefficient in a voltage correction value calculation unit installed in the controller in the inverter device according to the embodiment.

FIG. 7 is a block diagram illustrating a specific constitution of the voltage correction value calculation unit installed in the controller in the inverter device according to the embodiment.

FIG. 8A is a circuit diagram illustrating a specific constitution of an LC filter and a load, and FIG. 8B is an explanatory diagram illustrating a difference in phase between voltage and current output from the inverter device.

FIG. 9 is a flowchart illustrating a processing procedure of the inverter device according to the embodiment.

### DESCRIPTION OF THE EMBODIMENTS

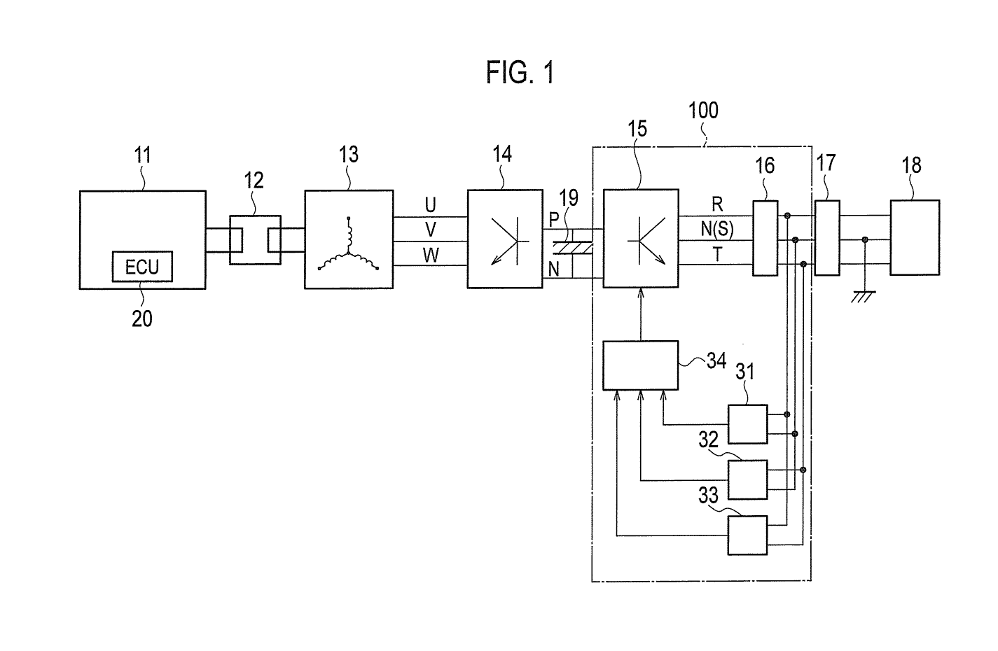

Hereinafter, an embodiment is explained with reference to the drawings. As illustrated in FIG. 1, an inverter generator according to the embodiment includes an engine (a prime mover) 11 such as a diesel engine or a gasoline engine, a synchronous motor 13 that generates three-phase AC induced voltage of each of a U phase, a V phase, and a W phase by the rotation of the engine 11, and a coupling 12 connecting an output shaft of the engine 11 and a rotation shaft of the synchronous motor 13.

The inverter generator includes a converter 14 connected to the synchronous motor 13 to convert, into PN DC voltage, each induced voltage of the U phase, the V phase, and the W phase output from the synchronous motor 13, an inverter device 100 that generates, from the PN DC voltage output from the converter 14, single-phase three-wire AC voltage of each of an R phase, an N phase, and a T phase or three-phase AC voltage of each of an R phase, an S phase, and a T phase, and a main circuit capacitor 19 installed in a PN coupling wire connecting the converter 14 and the inverter device 100.

The inverter device 100 on the output side is connected to a load 18 such as an induction motor via a breaker 17. It should be noted that, although only one breaker 17 and one load 18 are illustrated in FIG. 1, a plurality of breakers and a plurality of loads are generally installed on the rear side of an LC filter 16. A PM motor may be used for the synchronous motor 13, in which permanent magnet is used for a rotor.

The embodiment exemplifies the inverter device that generates AC voltage of the single-phase three-wire system of the R phase, the N phase, and the T phase.

The inverter device 100 includes a switching circuit 15, the LC filter 16 that reduces switching noise caused in the switching circuit 15, voltage sensors 31, 32, 33 that measure line-to-line voltage among the R phase, the N phase, and the T phase in the inverter device 100, and a controller 34 that controls the switching circuit 15. The first voltage sensor 31 measures line-to-line voltage between the R phase and the N phase (hereinafter, referred to as “RN voltage”), the second voltage sensor 32 measures line-to-line voltage between the T phase and the N phase (hereinafter, referred to as “TN voltage”), and the third voltage sensor 33 measures line-to-line voltage between the R phase and the T phase. Note that FIG. 1 exemplifies the inverter device 100 with the single-phase three-wire system in which the N phase is a ground phase.

The engine 11 is connected to an engine control unit (ECU) 20 that controls the rotation of the engine 11.

The converter 14 includes a plurality of switching devices such as transistors, IGBT, or MOSFET and a plurality of diodes which are semiconductor devices. The converter 14 operates the respective switching devices so as to convert each three-phase AC voltage of the U phase, the V phase, and the W phase into the PN DC voltage. The converter 14 allows current to flow into the synchronous motor 13 as appropriate depending on electric power to be output to the load 18 so as to generate desired electric power without frequently changing the rotation speed of the engine 11. Namely, in contrast to common rectifiers, the converter 14 generates the PN DC voltage having desired volume from the three-phase AC voltage output from the synchronous motor 13 and allows the current to flow into the synchronous motor 13 depending on the electric power to be output to the load, so as to stably generate the electric power according to load variations.

The main circuit capacitor 19 functions to smooth the PN DC voltage and store electric power so that the switching circuit 15 can output a large amount of electric power.

The switching circuit 15 installed in the inverter device 100 includes, as in the case of the converter 14, a plurality of switching devices such as transistors, IGBT, or MOSFET and a plurality of diodes which are semiconductor devices, and operates the respective switching devices so as to generate each single-phase three-wire AC voltage of the R phase, the N phase, and the T phase. Namely, the switching circuit 15 converts the DC power into the AC power. Further, the switching circuit 15 can set, to arbitrary values, the output voltage and output frequencies from the inverter device 100 according to switching patterns of the respective switching devices.

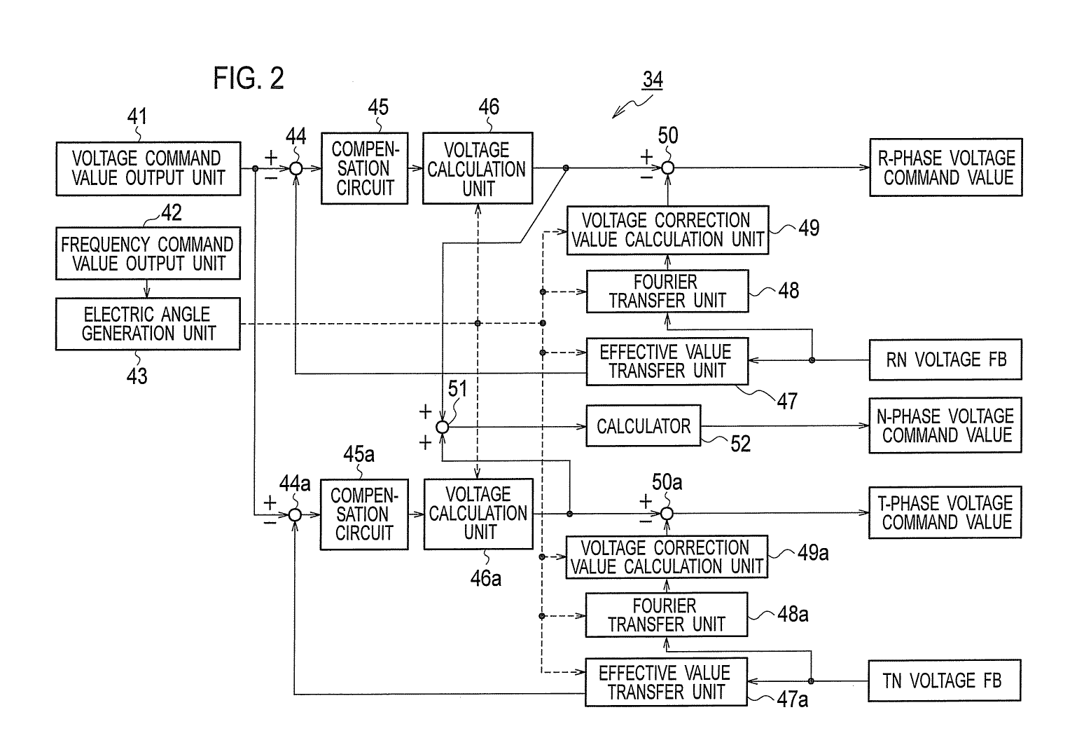

Next, the constitution of the controller 34 installed in the inverter device 100 is explained in detail below. As illustrated in FIG. 2, the controller 34 includes a voltage command value output unit 41 that generates and outputs a command value of voltage (a voltage command value; for example, 100 V) to be output from the switching circuit 15, a frequency command value output unit 42 that outputs a frequency command value (for example, 50 Hz), and an electric angle generation unit 43 that generates an electric angle in the range from 0° to 360° based on the frequency command value output from the frequency command value output unit 42.

The controller 34 includes, as constituent elements to generate an R-phase voltage command value, a first effective value conversion unit 47, a first Fourier transform unit 48 (a frequency analysis unit), a first voltage correction value calculation unit 49 (a correction signal generation unit), a compensation circuit 45, a voltage calculation unit 46, a first subtractor 44, and a second subtractor 50. The controller 34 further includes constituent elements to generate a T-phase voltage command value which are the same as the case of generating the R-phase voltage command value and are indicated by reference numerals each being accompanied by a suffix “a” in FIG. 2. The following is an explanation of the constituent elements to generate the R-phase voltage command value.

The effective value conversion unit 47 converts, into an effective value, the RN voltage (a feedback value) detected by the first voltage sensor 31 based on electric angle data output from the electric angle generation unit 43 and outputs the effective value data to the first subtractor 44. The first subtractor 44 calculates a deviation between the voltage command value and the feedback value of the RN voltage and outputs the deviation data to the compensation circuit 45.

The Fourier transform unit 48 performs Fourier transform (frequency analysis) on the RN voltage based on the electric angle data and outputs the obtained frequency data to the voltage correction value calculation unit 49.

The voltage correction value calculation unit 49 calculates voltage correction coefficients based on the frequency data output from the Fourier transform unit 48 and the electric angle data output from the electric angle generation unit 43 and outputs the voltage correction coefficients thus obtained to the second subtractor 50. When there are harmonics (frequency components such as three or five times greater than the frequency of the AC power) as a result of the Fourier transform, the voltage correction value calculation unit 49 calculates the voltage correction coefficients for cancelling the harmonics and outputs the coefficients to the second subtractor 50. The specific method of calculating the voltage correction coefficients will be explained below.

The compensation circuit 45 compensates the voltage command value in a manner such that the deviation obtained by the first subtractor 44 is zero.

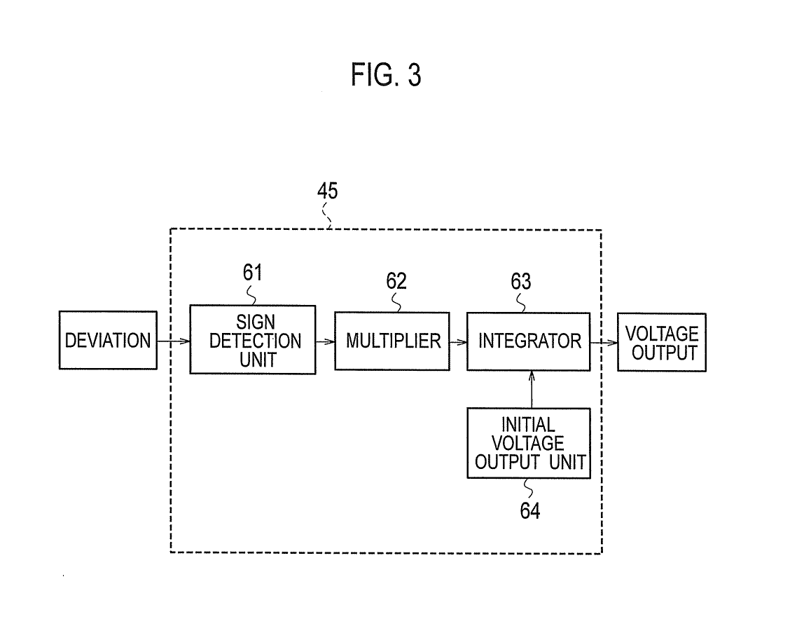

As illustrated in FIG. 3, the compensation circuit 45 includes a sign detection unit 61, a multiplier 62 for multiplying an incremental gain Ka, an integrator 63, and an initial voltage output unit 64 that applies an initial value to the integrator 63.

The sign detection unit 61 determines whether the sign of the deviation is plus or minus or whether the deviation is zero when the deviation data calculated by the first subtractor 44 is applied thereto. The sign detection unit 61 sets output data to “1” when the sign of the deviation is plus regardless of the level of the deviation, sets output data to “−1” when the sign of the deviation is minus regardless of the level of the deviation, and sets output data simply to zero when the deviation is zero.

The multiplier 62 multiplies the sign data output from the sign detection unit 61 and the incremental gain Ka. The integrator 63 integrates the output data from the multiplier 62 and further adds initial voltage output from the initial voltage output unit 64. The integrator 63 outputs the calculation result as a corrected voltage command value. Here, the initial voltage is an initial value in the integrator 63 and may be voltage corresponding to the voltage command value or may be a command value close to preliminarily estimated voltage output.

The advantage of the use of the compensation circuit 45 is that, when the deviation output from the first subtractor 44 exceeds “0” (when the output voltage is smaller than the command voltage), the output data from the sign detection unit 61 is immediately set to “1” so as to increase the voltage output. As a result, the plus/minus voltage output can be kept around the deviation zero point. In other words, the response speed of the voltage feedback can be improved. Here, if a conventional proportional integral (PI) control is employed, at least an overshoot or undershoot may be caused, which may lead to oscillation in the voltage control. However, the system of the compensation circuit 45 can prevent the oscillation by appropriately setting the incremental gain Ka. On the other hand, the response is delayed when the deviation is large because the change of the voltage command value is the same regardless of whether the deviation is large or small (whether “1” or “−1”, the value is constant). With regard to this, the incremental gain Ka may be set as appropriate depending on individual control patterns according to specifications.

The voltage calculation unit 46 calculates the voltage command value based on the voltage output obtained by the compensation circuit 45 and outputs the calculated value to the second subtractor 50.

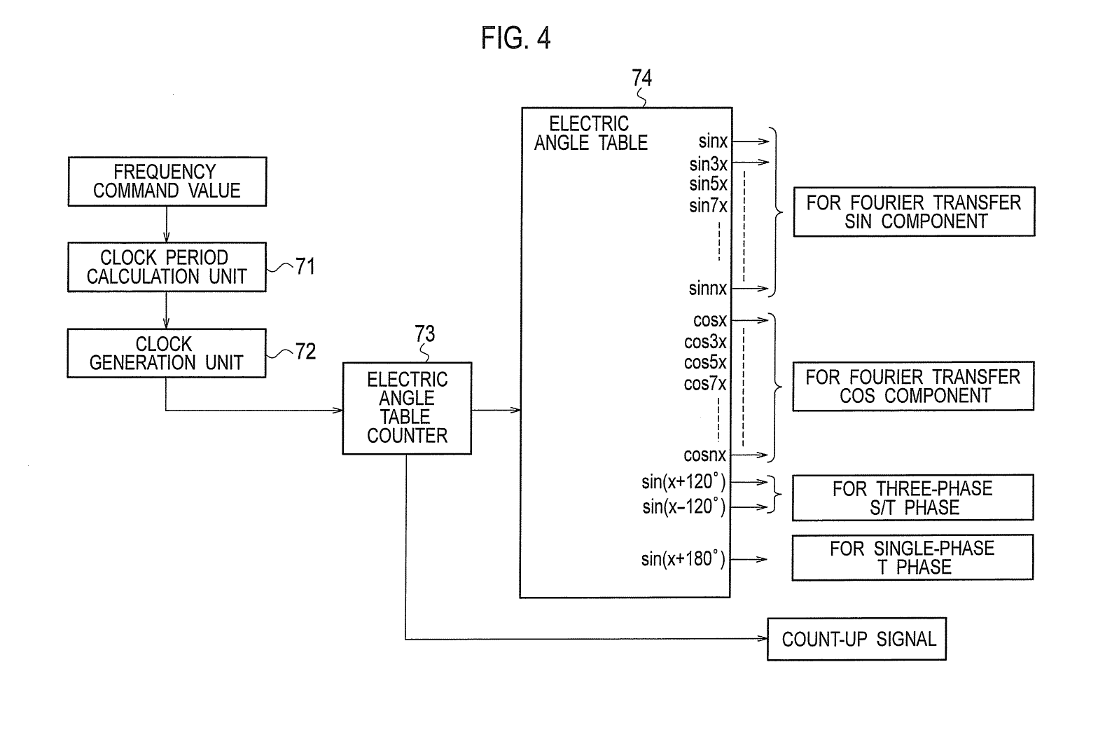

Next, the specific constitution of the electric angle generation unit 43 is explained with reference to the block diagram illustrated in FIG. 4. The electric angle generation unit 43 includes a clock period calculation unit 71 that calculates a clock period for electric angle count with respect to the frequency command value (for example, 50 Hz), a clock generation unit 72 that generates a clock signal based on the period calculated by the clock period calculation unit 71, an electric angle table counter 73, and an electric angle table 74.

The clock period calculation unit 71 calculates the clock period (a count value) according to the following equation (1).

Clock period (count value)=basic clock/4096/frequency [Hz] (1)

That is, when the basic clock is N [count/second] and when the frequency of the output power is 50 [Hz], the count value per period of the output power is N/50 [count]. Further, one period is divided into 4096. Accordingly, N/(50×4096) can be determined as the clock period, and 0 to 4095 can be set to one period.

The clock generation unit 72 generates one clock by count-up calculation of the clock period (the count value) obtained according to the equation (1) and outputs the clock signal (N/(50×4096)) to the electric angle table counter 73. The electric angle table counter 73 counts up from 0 to 4095 by use of the clock signal generated by the clock generation unit 72 and outputs the count value to the electric angle table 74. When counting up (from 0 to 4095), the count-up signal is output. Note that, although the embodiment exemplifies the case where one period is divided into 4096, this may be determined according to circumstances depending on accuracy of voltage correction.

The electric angle table 74 stores a numerical value (in the range from −1 to 1, defined as an electric angle) with respect to a sine wave (sin x), a cosine wave (cos x) and harmonics thereof (sin 3x, sin 5x, . . . , cos 3x, cos 5x, . . . ) corresponding to the count value obtained by the electric angle table counter 73. For example, when the count value is “1023”, this indicates a quarter period and sin 90°=1 is stored as an electric angle corresponding to “sin x” in the electric angle table.

In the case of a single-phase three-wire system, data of sin(x +180°) is output since the T phase is shifted by 180° from the R phase. In the case of a three-phase three-wire system, data of sin(x+120°) and data of sin(x−120°) are output since there are the S phase which is 120° leading of the R phase and the T phase which is 120° lagging the R phase.

Each electric angle data output from the electric angle table 74 is output to the voltage calculation unit 46, the effective value conversion unit 47, the Fourier transform unit 48, and the voltage correction value calculation unit 49.

Next, the circuit for preventing harmonics generated in the voltage output in the inverter device 100 is explained below. The generation condition of the harmonics varies depending on dead time of PWM of the voltage output and depending on the difference between loads to be connected (such as resistor, inductor, and capacitor). The level of the harmonics also varies depending on the condition where the inverter device or the like is connected as the loads and depending on the magnitude of the loads. Thus, continuously-operated corrections are required. According to the embodiment, the controller 34 is equipped with the Fourier transform unit 48 and the voltage correction value calculation unit 49 so as to output a correction command for preventing the harmonics.

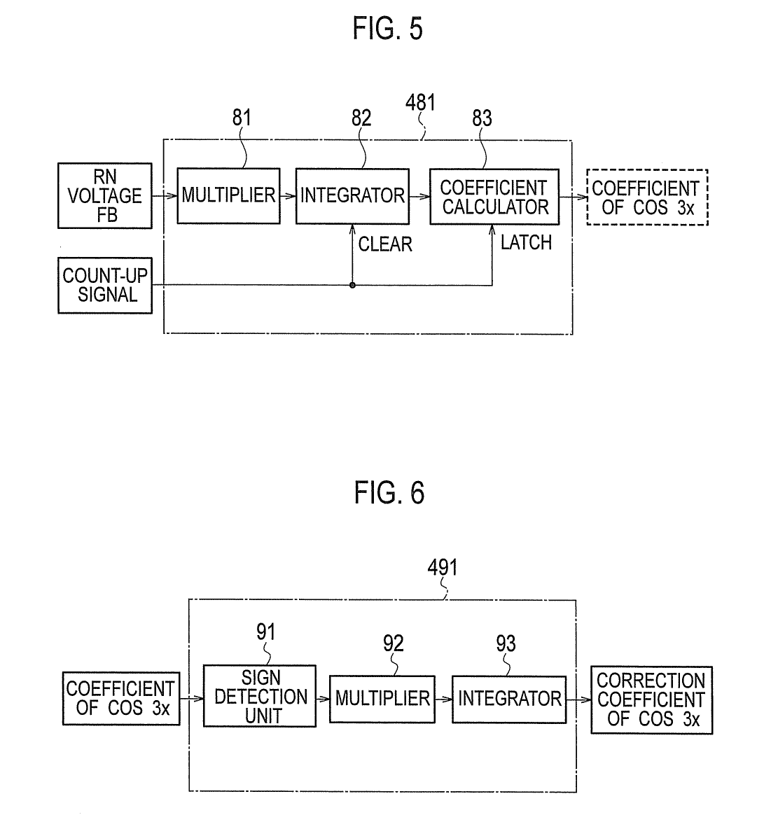

FIG. 5 is a block diagram illustrating a partial constitution of the Fourier transform unit 48 and illustrating a constitution of a calculator 481 for obtaining a coefficient A₃ with regard to “cos 3x”. The Fourier transform unit 48 performs the Fourier transform to the AC voltage and calculates a harmonic of each degrees. As for the equation for the Fourier transform, in general, the frequency function f(x) for the Fourier transform is indicated by the following equation (2). In addition, the respective coefficients Aₙ, and Bₙ (n=1, 2, 3, . . . ) indicated in the equation (2) can be obtained by equations (3) and (4) respectively.

$$\begin{matrix}f ( x ) = {A}_{0} + {A}_{1} cos x + {A}_{2} cos 2 x + … + {A}_{n} cos nx + {B}_{0} + {B}_{1} sin x + {B}_{2} sin 2 x + … + {B}_{n} sin nx & ( 2 ) \\ {A}_{n} = \frac{1}{π} {\int }_{0}^{2 π} f ( x ) cos nx d x & ( 3 ) \\ {B}_{n} = \frac{1}{π} {\int }_{0}^{2 π} f ( x ) sin nx d x & ( 4 )\end{matrix}$$

The Fourier transform unit 48 further includes other calculators for calculating the respective coefficients, other than “cos 3x”, for cos x, cos 5x, cos 7x, . . . , and sin x, sin 3x, sin 5x, sin 7x, . . . as in the case of the calculator illustrated in FIG. 5.

As illustrated in FIG. 5, the calculator 481 includes a multiplier 81, an integrator 82, and a coefficient calculator 83. The multiplier 81 multiplies the feedback value of the RN voltage by the coefficient of “cos 3x”. The integrator 82 obtains an integral value by adding the coefficient obtained by the multiplier 81 per predetermined sampling time. The coefficient calculator 83 obtains an integral value for one period according to the integral value calculated by the integrator 82 and latches the value by the count-up signal. The coefficient calculator 83 then outputs the value as the coefficient “A₃” of “cos 3x”. When the count-up signal (the signal indicating the end of one period of the electric angle) is applied, the integral value obtained by the integrator 82 is cleared.

The same processing is performed also on the other degrees (other frequencies) so as to calculate the coefficient “A₅” of “cos 5x”, the coefficient “A₇” of “cos 7x”, . . . , the coefficient “B₃” of “sin 3x”, . . . , and so on. The coefficient calculator 83 obtains the coefficient by dividing by the number of integration. Note that the calculation to divide by the number of integration may be omitted and the integral value may be directly used as the coefficient since the coefficient is only required to result in zero in the end.

Here, when the sine waves output from the switching circuit 15 do not include any harmonics, that is, when there is no distortion in the sine waves, the harmonics A₃, A₅, . . . , B₃, B₅, . . . are all zero.

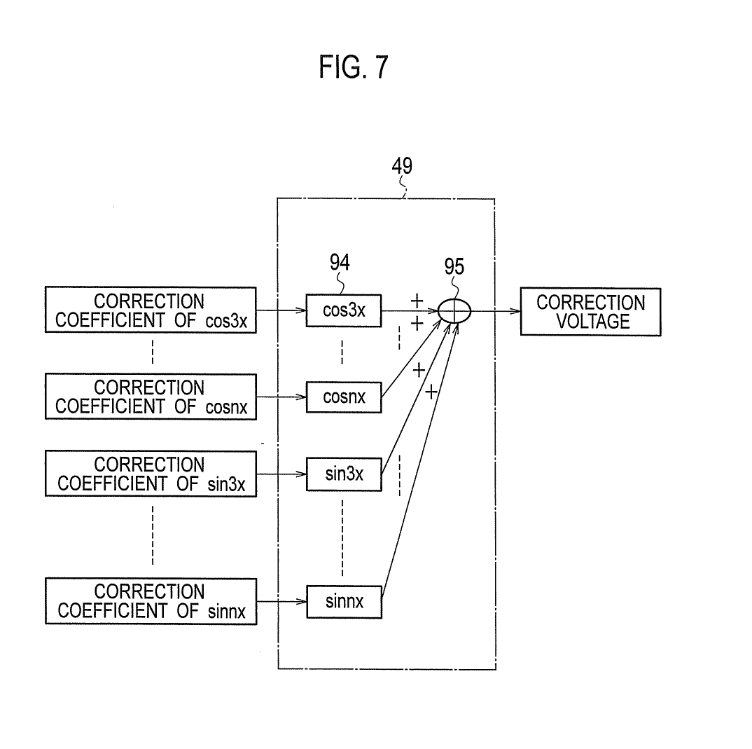

Next, the specific constitution of the voltage correction value calculation unit 49 is explained with reference to FIGS. 6 and 7. FIG. 6 is a block diagram illustrating a constitution of a calculator 491 in the voltage correction value calculation unit 49 to calculate a correction coefficient of “cos 3x”. As illustrated in FIG. 6, the calculator 491 includes a sign detection unit 91 that detects the sign of the coefficient, a multiplier 92 that multiplies a predetermined correction gain Kb, and an integrator 93 that performs a calculation of integration.

The sign detection unit 91 detects and outputs the sign of the coefficient “A₃” of “cos 3x” when the coefficient “A₃” is applied thereto. The multiplier 92 multiplies the output data from the sign detection unit 91 by the correction gain Kb and outputs the multiplied result data to the integrator 93. The integrator 93 defines the output data as a correction coefficient value of “cos 3x”. The correction gain Kb is used to determine the response speed of correction, and an appropriate value is assigned thereto so as to perform the correction at an appropriate speed without oscillation. The calculator is provided for each coefficient to calculate correction coefficients of cos 3x, cos 5x, . . . , sin 3x, sin 5x, . . . , and so on.

FIG. 7 is a block diagram illustrating a constitution of the voltage correction value calculation unit 49 for obtaining the correction voltage by adding the correction coefficients calculated for the respective degrees. When the correction coefficients are calculated for the respective degrees as illustrated in FIG. 6, electric angle data 94 for each degree set in the electric angle table 74 illustrated in FIG. 4 is multiplied by each correction coefficient. Further, an adder 95 adds the multiplied result for each degree so as to obtain the correction voltage. The correction voltage thus obtained is output to the second subtractor 50.

Here, as illustrated in FIG. 2, the voltage correction value of each phase (R, N, T) is subtracted from the voltage calculation value obtained by the voltage control by use of the above-described effective value so that the result thus obtained is used as the voltage command value of each phase. Although the calculation procedure of the voltage command value of the R phase has been explained above, the same calculation procedure may also be applied to the T phase. Here, the N phase is not subjected to correction. That is, an adder 51 (refer to FIG. 2) adds the voltage command value of the R phase output from the voltage calculation unit 46 and the voltage command value of the T phase output from the voltage calculation unit 46a, and a calculator 52 then multiplies the value thus obtained by “−1/2” so as to obtain a voltage command value of the N phase.

The constitution described above can perform the voltage correction for removing the harmonics caused in the voltage waveform. This control is on the principle that the coefficients for the respective degrees in the data obtained in a manner such that the feedback signal of each phase (the R phase, the T phase) is subjected to the Fourier transform, are brought close to zero, that is, the harmonics of each line-to-line voltage are thus brought close to zero, so as to avoid distortion caused in the waveform. Note that the control may be performed in a manner such that each degree is reduced to a small value depending on computational complexity or the magnitude of the harmonics.

In the method of preventing the harmonics as described above, when the load 18 having reactance components beyond an allowable range (mostly, load with large capacitance) is connected to the inverter device 100, the phase of the voltage may greatly lag behind the current so that the control diverges. Namely, a coefficient for one degree may not converge in a particular value. In such a case, the voltage correction value cannot be obtained stably and as a result, the control of the harmonic correction cannot be achieved.

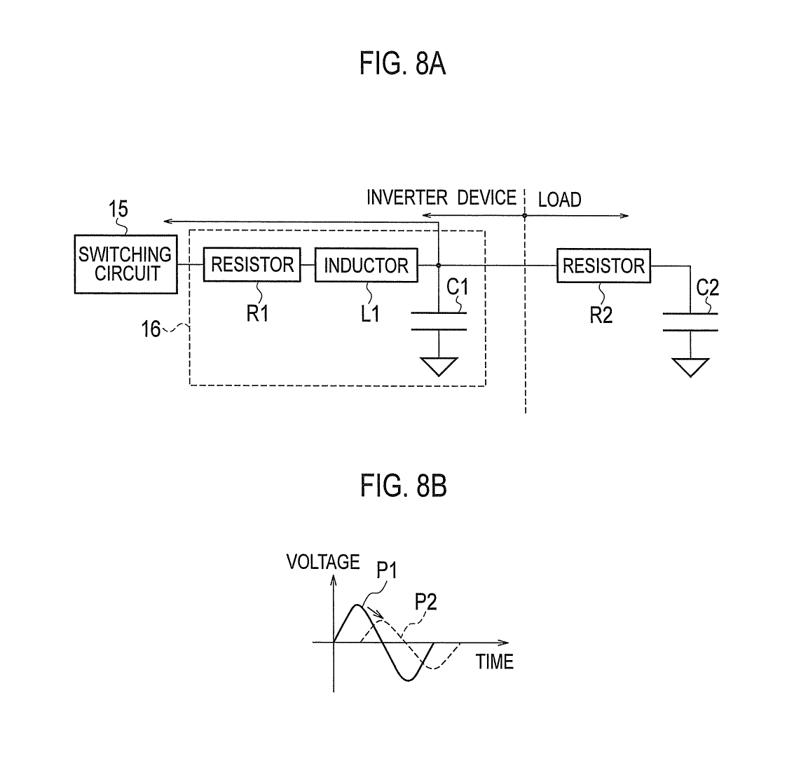

The reason thereof is explained below with reference to FIG. 8A. FIG. 8A is an equivalent circuit diagram of the LC filter 16 and the load 18 illustrated in FIG. 1.

As illustrated in FIG. 1, the LC filter 16 for smoothing a PWM waveform output from the switching circuit 15 to obtain sine waves, is located on the rear side of the switching circuit 15. The LC filter 16 includes a capacitor C1. When a capacitive load (such as a personal computer) is connected as the load 18, a capacitor C2 is added thereto, which leads to the increase of the capacitive load so as to cause a large difference in phase between the voltage detected by the respective voltage sensors 31 to 33 and the current. As a result, the control loop may be unstable because of the phase difference if such a voltage value is used as a feedback signal.

In other words, as illustrated in FIG. 8B, the phase of voltage signal P1 lags behind the phase of voltage signal P2 so that a stable control cannot be ensured, which may cause divergence of control depending on circumstances. In view of this, the present embodiment employs a self-determination function to stop correction of a harmonic signal of a corresponding degree when a Fourier transform value of a corrected voltage signal does not converge in smaller than a predetermined threshold value within a predetermined time. Namely, the switching circuit 15 is controlled in a manner such that the control is stopped for a degree which is not controllable so as to prevent divergence, and the voltage correction values are generated only for degrees which are controllable.

In particular, when the respective coefficients A₃, A₅, . . . , B₃, B₅, . . . of cos 3x, cos 5x, . . . , sin 3x, sin 5x . . . are calculated and some of the calculation results do not converge but diverge, the correction cannot be performed on the harmonics of the corresponding degrees. In such a case, the control performed on the harmonics of the diverging degrees is stopped, and only the coefficients of the harmonics which converge are calculated so as to obtain the voltage correction values. For example, when the correction coefficients of sin 7x and cos 7x diverge among the correction coefficients of the respective harmonics illustrated in FIG. 7, the correction voltage is calculated only by use of the correction coefficients of sin 3x, sin 5x, cos 3x, and cos 5x. Originally, this is based on the assumption that the control is not necessarily performed when a load with a capacity which is not controllable is connected since the harmonics are filtered and tend to decrease.

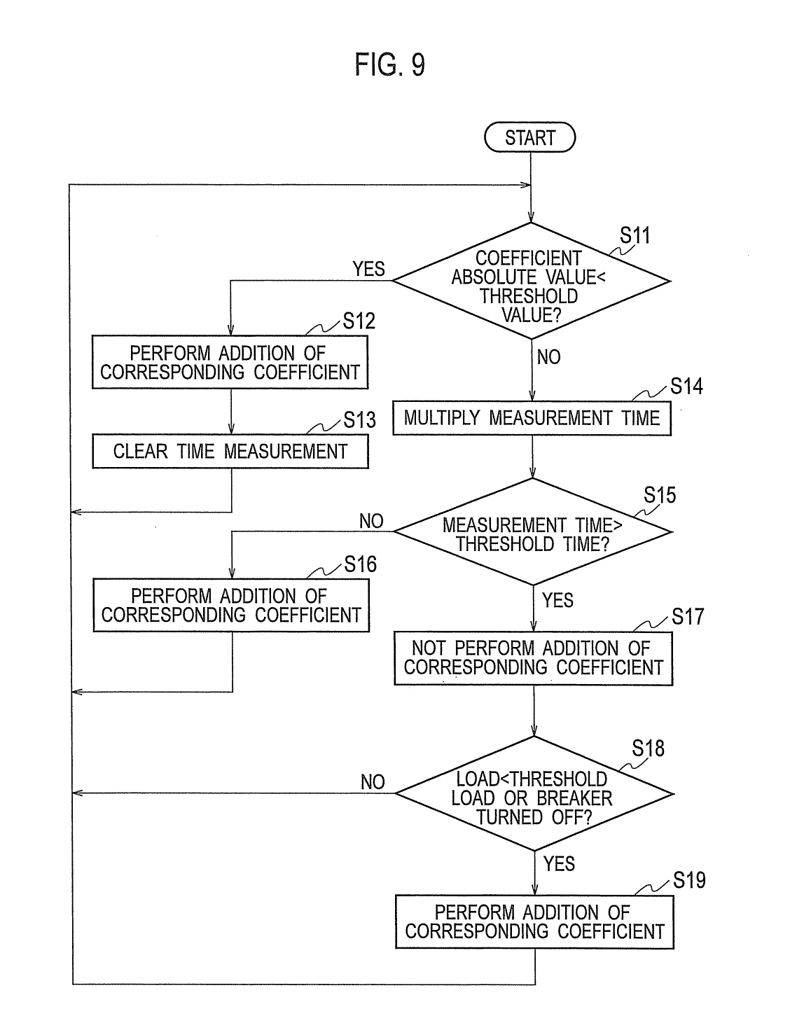

Next, the processing procedure of the inverter device according to the embodiment is explained with reference to the flowchart illustrated in FIG. 9. This processing is performed according to the calculation by the voltage correction value calculation unit 49 illustrated in FIG. 2. This processing is performed on each of the coefficients of the odd-multiple degrees (namely, A₁, A₃, A₅, . . . , B₁, B₃, B₅, . . . ). Note that the present embodiment uses the odd-multiple degrees because the influence of the harmonics is greatly derived from odd-multiple frequency components. Of course, frequencies of even-multiple degrees may also be used for the calculation. First, in step S11, the voltage correction value calculation unit 49 determines whether an absolute value of a coefficient is smaller than a threshold value. Namely, the coefficient of each degree (that is, A₁, A₃, A₅, . . . , B₁, B₃, B₅, . . . ) is compared with the threshold value. When the absolute value of the coefficient is smaller than the threshold value (YES in step S11), this coefficient is conceived to converge so that the corresponding coefficient is added in step S12. For example, when the coefficients A₃, A₅, B₃, and B₅ are smaller than the threshold value and the coefficients A₇, A₉, . . . , and B7, B9, . . . are larger than the threshold value, the correction coefficients of A₃, A₅, B₃ and B₅ are added. In particular, the correction coefficients of A₃, A₅, B₃, and B₅ are obtained in the processing illustrated in FIG. 6, and the correction voltage is calculated as illustrated in FIG. 7. Thereafter, the time measurement is cleared in step S13.

When the absolute value of the coefficient is larger than or equal to the threshold value (NO in step S11), the measurement time is integrated in step S14. In step S15, the voltage correction value calculation unit 49 determines whether the measurement time reaches a predetermined threshold time. When the measurement time does not reach the threshold time (NO in step S15), the corresponding coefficient is added in step S16. The processing then returns to step S11.

When the measurement time reaches the threshold time (YES in step S15), the corresponding coefficient is not added in step S17. For example, when the measurement time of each of the coefficients A₇, A₉, . . . , and B7, B9, . . . reaches the threshold time and the absolute values of these coefficients are larger than the threshold value, such coefficients are not added since these are not conceived to converge in a particular value but conceived to diverge.

Thereafter, in step S18, the voltage correction value calculation unit 49 determines whether the load connected to the inverter device 100 is smaller than a predetermined threshold load. When the load is smaller than the threshold load (YES in step S18), the corresponding correction coefficient is added in step S19, and the processing returns to step S11. Namely, when the condition of the load connected to the inverter device 100 changes and the cause of divergence of the coefficient is removed (when the breaker turns off), the corresponding coefficient is added. The processing then returns to step S11.

According to the processing described above, only the coefficients conceived to converge in a particular value (for example, A₃, A₅, B₃, and B₅) among the coefficients A₃, A₅, A₇, . . . and the coefficients B₃, B₅, B₇, . . . of the respective degrees are added, and the addition of the coefficients not conceived to converge is not carried out. Accordingly, the voltage correction values can be obtained stably so that the harmonics superposed on the voltage signal can be removed effectively.

As described above, in the inverter device according to the embodiment, the voltage value detected by the voltage sensor is subjected to the Fourier transform (frequency analysis) so that the coefficients of the harmonics for the respective degrees are obtained. In this case, the correction coefficients for the voltage command values are calculated by use of the coefficients thus obtained only when the coefficients converge, and the voltage command values are corrected by use of these correction coefficients. When the coefficients do not converge, such coefficients are not used for the calculation of the correction coefficients.

Since the correction coefficients are obtained only by use of the coefficients of the degrees which converge even when there is a large difference in phase between the voltage and the current supplied to the load because of the reactance components of the load, the voltage control with a high response speed and high stability can be ensured. Accordingly, the electric power can be supplied stably to the load 18 so as to properly operate the load 18 accordingly.

The embodiment exemplified the compensation circuit 45 having the constitution illustrated in FIG. 3. Alternatively, a common compensation device such as PID may be used instead of the compensation circuit 45. Note that a compensation device with higher stability should be selected since the control loop may be unstable depending on the condition of a load to be connected.

Although the inverter device 100 and the inverter generator according to the embodiment were explained above, the present invention is not limited thereto. The constitutions of the respective elements may be replaced with arbitrary elements having similar functions.

For example, instead of the single-phase three-wire power supply exemplified in the embodiment above, a three-phase three-wire power supply may also be used.

What is claimed is:

1. An inverter device, comprising:
a switching circuit that converts DC power into AC power based on a voltage command value; and
a controller that controls operation of the switching circuit,
the controller including:
a voltage command value output unit that outputs the voltage command value;
a voltage sensor that detects an output voltage from the switching circuit;
a frequency analysis unit that performs frequency analysis on the output voltage detected by the voltage sensor; and
a correction signal generation unit that obtains harmonics with respect to a drive frequency of the switching circuit subjected to the frequency analysis by the frequency analysis unit and calculates voltage correction coefficients for correcting the voltage command value so as to cancel the harmonics,
wherein the correction signal generation unit calculates coefficients each for each degree of the harmonics and determines whether each of the coefficients converges when calculating the coefficients so as to obtain the voltage correction coefficients based on the coefficients which are determined to converge.

2. The inverter device according to claim 1, wherein the correction signal generation unit determines that each of the coefficients converges when the calculated coefficient for each degree of the harmonics is within a predetermined threshold value.

3. The inverter device according to claim 2, wherein the correction signal generation unit determines that each of the coefficients converges when a measurement time for each of the coefficients is shorter than a predetermined period of time even when each of the coefficients for each degree of the harmonics is not within the predetermined threshold value.

4. An inverter generator, comprising:
a prime mover;
a synchronous motor connected to the prime mover;
a converter connected to the synchronous motor;
an inverter device connected to the converter; and
a capacitor installed between the converter and the inverter device,
wherein the prime mover rotates the synchronous motor, electric power generated by the synchronous motor is changed into DC power, the DC power is converted into AC power having a desired frequency by the inverter device,
the inverter device includes:
a switching circuit that converts the DC power into the AC power based on a voltage command value; and
a controller that controls operation of the switching circuit,
the controller includes:
a voltage command value output unit that outputs the voltage command value;
a voltage sensor that detects an output voltage from the switching circuit;
a frequency analysis unit that performs frequency analysis on the output voltage detected by the voltage sensor; and
a correction signal generation unit that obtains harmonics with respect to a drive frequency of the switching circuit subjected to the frequency analysis by the frequency analysis unit and calculates voltage correction coefficients for correcting the voltage command value so as to cancel the harmonic component, and
the correction signal generation unit calculates coefficients each for each degree of the harmonics and determines whether each of the coefficients converges when calculating the coefficients so as to obtain the voltage correction coefficients based on the coefficients which are determined to converge.

5. The inverter generator according to claim 4, wherein the correction signal generation unit determines that each of the coefficients converges when the calculated coefficient for each degree of the harmonics is within a predetermined threshold value.

6. The inverter generator according to claim 5, wherein the correction signal generation unit determines that each of the coefficients converges when a measurement time for each of the coefficients is shorter than a predetermined period of time even when each of the coefficients for each degree of the harmonics is not within the predetermine threshold value.
